(19) United States
(12) Patent Application Publication
(10) Pub. No.: US 2025/0285812 A1
(43) Pub. Date: Sep. 11, 2025

(54) VARIABLE CAPACITOR AND POWER SUPPLY APPARATUS

(71) Applicant: DENSO CORPORATION, Kariya-city (JP)

(72) Inventors: Takuya KIGUCHI, Kariya-city (JP); Masaya TAKAHASHI, Kariya-city (JP); Nobuhisa YAMAGUCHI, Kariya-city (JP); Yasuyuki HIKITA, Kariya-city (JP); Keisuke TANI, Kariya-city (JP)

(73) Assignee: DENSO CORPORATION, Kariya-city (JP)

(21) Appl. No.: 19/219,482

(22) Filed: May 27, 2025

Related U.S. Application Data
(63) Continuation of application No. PCT/JP2024/002138, filed on Jan. 25, 2024.

(30) Foreign Application Priority Data
Feb. 2, 2023 (JP) 2023-014372

(51) Int. Cl. H01G 7/06; H02M 3/335

(52) U.S. Cl. CPC H01G 7/06; H02M 3/335

(57) ABSTRACT

A variable capacitor for a control circuit controlling an apparatus includes: a first control electrode layer, a second control electrode layer, a dielectric layer between the first control electrode layer and the second control electrode layer, and a first lead-out electrode layer and a second lead-out electrode layer facing each other via the dielectric layer. The first lead-out electrode layer and the second lead-out electrode layer are arranged at a portion causing an electric field along a direction intersecting an electric field vector produced between the first control electrode layer and the second control electrode layer when a voltage is applied between the first control electrode layer and the second control electrode layer, and a voltage applied between the first control electrode layer and the second control electrode layer is adjusted to adjust a capacitance between the first lead-out electrode layer and the second control electrode layer.

### CROSS-REFERENCE OF RELATED APPLICATIONS

This application is the U.S. bypass application of International Application No. PCT/JP2024/002138 filed on Jan. 25, 2024, which designated the U.S. and claims priority to Japanese Patent Application No. 2023-014372 filed on Feb. 2, 2023, and the contents of both of these are incorporated herein by reference.

### BACKGROUND

### Technical Field

The present disclosure relates to a variable capacitor and a power supply apparatus.

### Description of the Related Art

Conventionally, a capacitor having a variable capacitance in which a dielectric layer is disposed between a pair of electrodes to be applied with a DC bias voltage is known. According to a conventional capacitor, a dielectric layer is disposed between the earth electrode and the DC bias electrode and a capacitance acquisition electrode is disposed via the dielectric layer between the earth electrode and the DC bias electrode. A DC bias voltage is applied between the earth electrode and the DC bias electrode, whereby the dielectric characteristics are changed to cause a change in the capacitance of the capacitor.

### SUMMARY

As a first aspect of the present disclosure, a variable capacitor used for a control circuit that controls an operation of an apparatus is provided. The variable capacitor includes: a first control electrode layer, a second control electrode layer that faces the first control electrode layer, a dielectric layer disposed at least between the first control electrode layer and the second control electrode layer; and a first lead-out electrode layer and a second lead-out electrode layer facing each other via the dielectric layer.

### BRIEF DESCRIPTION OF THE DRAWINGS

The above-described objects and other objects, features and advantages of the present disclosure will be clarified further by the following detailed description with reference to the accompanying drawings. The drawings are:

FIG. 1 is a schematic diagram showing a non-contact power supply system;

FIG. 2 is a circuit diagram showing a non-contact power supply system;

FIG. 3 is a diagram showing a perspective view of a variable capacitor,

FIG. 4 is a diagram showing a cross-sectional view of the variable capacitor sectioned at line IV-IV shown in FIG. 3;

FIG. 5 is a diagram showing a relationship between a control electric field and a relative dielectric constant;

FIG. 6 is a circuit diagram of a power supply apparatus;

FIG. 7 is a circuit diagram of a power supply apparatus according to a second embodiment;

FIG. 8 is a circuit diagram of a power supply apparatus according to a third embodiment;

FIG. 9 is a circuit diagram of a power supply apparatus according to a fourth embodiment;

FIG. 10 is a graph showing a relationship between a timing at which a control voltage starts to be applied and a coil voltage; and

FIG. 11 is a graph showing dielectric characteristics of a dielectric layer according to a fifth embodiment.

### DETAILED DESCRIPTION OF THE PREFERRED EMBODIMENTS

As a related art, for example, JP-A-2006-344845 discloses a capacitor having a variable capacitance in which a dielectric layer is disposed between a pair of electrodes to be applied with a DC bias voltage. According to the above-mentioned capacitor, a dielectric layer is disposed between the earth electrode and the DC bias electrode and a capacitance acquisition electrode is disposed via the dielectric layer between the earth electrode and the DC bias electrode. A DC bias voltage is applied between the earth electrode and the DC bias electrode, whereby the dielectric characteristics are changed to cause a change in the capacitance of the capacitor.

According to the above-described conventional capacitors, the earth electrode, the DC bias electrode and the capacitance acquisition electrode are laminated in the same direction via the dielectric layer. Hence, a distance between the earth electrode and the DC bias electrode is required to be set in conjunction with a distance between the earth electrode and the capacitance acquisition electrode.

Hereinafter, embodiments of the present disclosure will be described.

### A. First Embodiment

### A1. Configuration of Non-Contact Power Supply System:

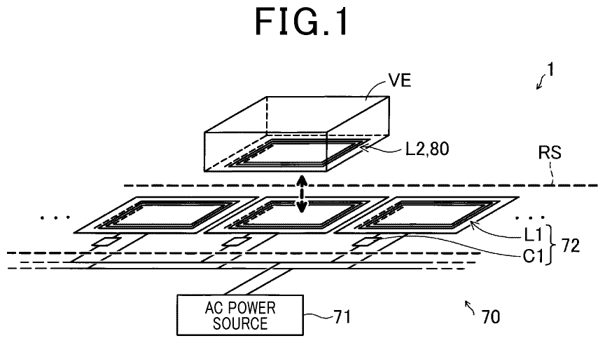

As shown in FIG. 1, the non-contact power supply system 1 is provided with a power supply apparatus 70 and a power reception apparatus 80. According to the present embodiment, the power supply apparatus 70 is buried in the road RS. The power reception apparatus 80 is mounted on a vehicle VE as a mobile body travelling on the road RS. The power reception apparatus 80 is supplied with power from the power supply apparatus 70 during the traveling of the vehicle VE. Note that ‘traveling’ includes a case where the vehicle VE is traveling and a case where the vehicle is stopped waiting for a signal change or the like. The vehicle VE is configured as an electric vehicle or a hybrid vehicle.

The power supply apparatus 70 includes a primary coil L1, a primary resonant circuit 72 as a series resonant circuit having a variable capacitor C1 and an AC power source 71 that supplies power to the primary resonant circuit 72. The AC power source 71 supplies power to a plurality of primary resonant circuits 72. The plurality of primary coils L1 are arranged in a direction along which the road RS extends. The power reception apparatus 80 includes a secondary coil L2.

The mobile body having the power reception apparatus 80 mounted thereon is not limited to the vehicle VE traveling on the road RS, but may be an AGV (automatic guided vehicle) or a mobile robot for example. The power supply apparatus 70 may be installed not under the road RS but may be on a side walk or a parking place next to the road RS, or a route where the AGV travels.

### A2. Circuit Configuration of Non-Contact Power Supply System:

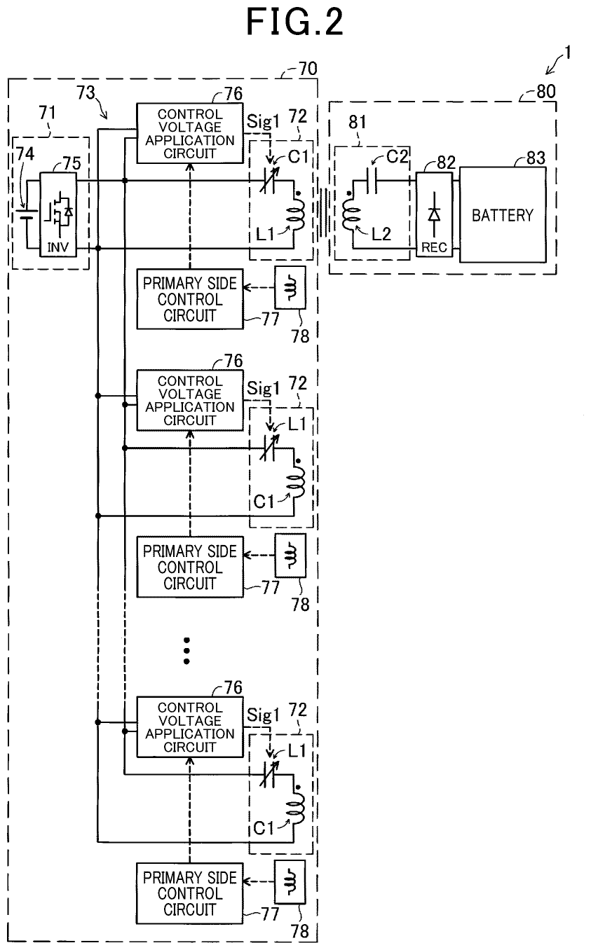

As shown in FIG. 2, the power supply apparatus 70 is provided with a control circuit 73 and a primary detection circuit 78 in addition to the above-described configuration. The control circuit 73 includes a control voltage application circuit 76 and a primary control circuit 77. The primary coil L1 and the variable capacitor C1 are connected in series to constitute a resonant circuit 72 as a resonant circuit.

The control circuit 73 adjusts electric field applied between the first control electrode layer 21 and the second control electrode layer 22 to adjust a capacitance value of electrostatic capacitance stored between the first lead-out electrode layer 11 and the second control electrode layer 22, thereby controlling an operation of the power supply apparatus 70. The control voltage application circuit 76 applies control voltage between the first control electrode layer 21 and the second control electrode layer 22. The control voltage is for changing the dielectric constant of the second dielectric layer 32. The variable capacitance C1 is used to adjust the capacitance value using the control voltage, thereby adjusting the resonant frequency of the primary resonant circuit 72.

The AC power source 71 includes a DC power source 74 and an inverter 75. The inverter 75 converts the DC power supplied from the DC power source 74 to an AC power having a predetermined operating frequency and applies the converted AC power to the primary resonant circuit 72. According to the present embodiment, the operating frequency is 85 KHz. The variable capacitor C1 has a function for causing the primary resonant circuit 72 to be in a resonant state at the operating frequency and causing the primary resonant circuit 72 to be in a non-resonant state at the operating frequency. According to the present embodiment, the variable capacitor C1 is configured to be capable of changing the capacitance between a first capacitance and a second capacitance smaller than the first capacitance. Then, the capacitance of the variable capacitor C1 is changed to be either the first capacitance or the second capacitance using a changing signal Sig1 outputted from the control voltage application circuit 76. In the case where the primary coil L1 and the secondary coil L2 are magnetically coupled and the capacitance of the variable capacitor C1 is at the first capacitance, the primary resonant circuit 72 is in a resonant state at the operating frequency. That is, the first capacitance of the variable capacitor C1 is set such that the resonant frequency of the primary resonant circuit 72 corresponds to a resonant state at the operating frequency. In contrast, when the variable capacitance C1 is the second capacitance, since the resonant frequency of the primary resonant circuit 72 is deviated from the operating frequency, the primary resonant circuit 72 is in a non-resonant state at the operating frequency.

The control voltage application circuit 76 applies the changing signal Sig1 generated using the AC power outputted from the AC power source 71 to the variable capacitance C1.

The primary detection circuit 78 serves as a magnetic sensor that detects a magnitude of magnetic flux in the vicinity of the primary coil L1, specifically, a magnetic sensor integrating a coil disposed in the vicinity of the primary coil L1. The primary detection circuit 78 detects magnetic flux density and outputs a signal indicating the detected magnetic flux density to the primary side control circuit 77. The primary side control circuit 77 utilizes a signal outputted from the primary detection circuit 78 and commands the control voltage application circuit 76 to change the voltage value of the change signal Sig1 applied to the variable capacitor C1. Specifically, the primary side control circuit 77 commands, when the magnetic flux density indicated by the signal is higher than a predetermined threshold, the control voltage application circuit 76 to change the voltage value of the change signal Sig1 applied to the variable capacitor C1.

The power reception apparatus 80 includes a secondary resonant circuit 81, a rectifier 82 and a battery 83 in addition to the above-described configuration. The secondary coil L2 and the secondary capacitor C2 are connected in series to constitute the secondary resonant circuit 81. The rectifier 82 converts the AC power outputted from the secondary resonant circuit 81 to be a DC power and supplies the battery 83 with the converted DC power. The battery 83 is charged by the supplied DC power.

The resonant frequency of the primary resonant circuit 72 and the resonant frequency of the secondary resonant circuit 81 are set to be substantially the same in the case where the primary coil L1 and the secondary coil L2 are magnetically coupled. Thus, with magnetic field resonance between the primary coil L1 and the secondary coil L2, the power reception apparatus 80 can be supplied with power in non-contact manner.

### A3. Standby State and Transmission State

A power supply state is defined as a state where the variable capacitor C1 is set to be the first capacitance, a transmission current flows through the primary coil L1 and the power is being supplied. Also, a standby state is defined as a state where the variable capacitance C1 is set to be the second capacitance, a standby current smaller than the transmission current flows through the primary coil L1 and the power is not being supplied.

The primary coils L1 are arranged in a direction in which the road RS extends, and the secondary coil L2 is supplied with power from the closest primary coil L1 in a non-contact manner. In the standby state, a standby current flows through the primary current L1, thereby causing the primary coil L1 to produce magnetic flux. The reception apparatus 80 is provided with a magnetic sensor which is not shown. Then, when the power reception apparatus approaches an object primary resonant circuit 72, the magnetic sensor detects magnetic flux produced by the primary coil L1. In the case where the power reception apparatus 80 detects magnetic flux, the power reception apparatus 80 causes AC current to flow through the secondary coil L2, thereby producing magnetic flux. When the primary detection circuit 78 detects the magnetic flux produced by the secondary coil L2, the primary side control circuit 77 commands the control voltage application circuit 76 to change the voltage value of the change signal Sig1. The variable capacitor C1 utilizes the voltage value of the change signal Sig1 and changes the capacitance to be the first capacitance from the second capacitance. Thus, the primary resonant circuit 72 is in a resonant state to start a power supply operation.

A method executed by the power supply apparatus 70 for determining whether the secondary coil L2 is present is not limited to the above-described method. For other embodiments, an embodiment in which the power supply apparatus 70 detects current flowing through the primary coil L1 to detect an increase in the current, an embodiment in which the power supply apparatus 70 detects the voltage of the primary coil L1 to detect an increase in the voltage may be employed.

### A4. Structure of Variable Capacitor:

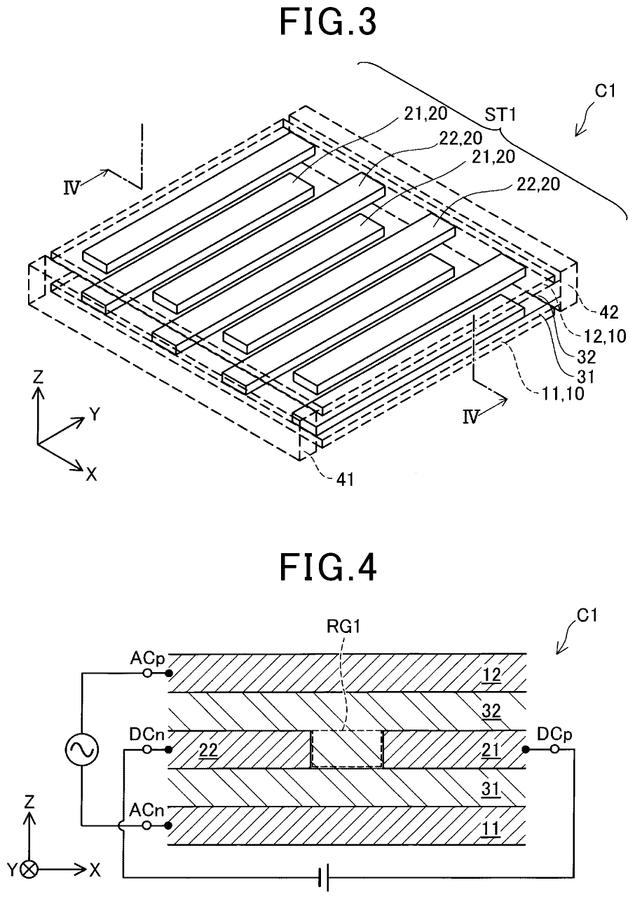

As shown in FIG. 3, the variable capacitor C1 includes a first lead-out electrode layer 11, a second lead-out electrode layer 12, a first control electrode layer 21, a second control electrode layer 22, a first dielectric layer 31, a second dielectric layer 32, a first lead-out electrode common layer 41 and a second lead-out electrode common layer 42. The first lead-out electrode layer 11 and the second lead-out layer 12 are also referred to as a lead-out electrode layer 10. Further, the first control electrode layer 21 and the second control electrode layer 22 are also referred to as a control electrode layer 20.

In FIG. 3, X, Y and Z axes are depicted as three special axes which cross each other. The arrow directions of the X, Y and Z axes indicate positive directions along respective X, Y and Z axes. The positive directions along respective X, Y and Z axes are defined as +X direction, +Y direction and +Z direction, respectively. Directions opposite to the arrow directions of the X, Y and Z axes are negative directions along the X, Y and Z directions, respectively. The negative directions along respective X, Y and Z axes are defined as the −X direction, −Y direction and −Z direction, respectively. Moreover, directions regardless of positive or negative directions are referred to as X direction, Y direction and Z direction, respectively. The similar applies to the subsequent drawings and descriptions.

As shown in FIG. 4, the first control electrode layer 21 and the second control electrode layer 22 serve as electrode layers which adjust the electrostatic capacitance of the variable capacitor C1. The first lead-out electrode layer 11 and the second lead-out electrode layer 12 serve as electrode layers with which the electrostatic capacitance of the variable capacitor C1 is utilized. Typically, the variable capacitor C1 is utilized where a control voltage which is a DC voltage is applied between the first control electrode layer 21 and the second control electrode layer 22 and an AC power is applied between the first lead-out electrode layer 11 and the second lead-out electrode layer 12.

The variable capacitor C1 further includes a first terminal ACp, a second terminal ACn, a third terminal DCp and a fourth terminal DCn used for electrically connecting with an external circuit. The first terminal ACp is electrically connected to the first lead-out electrode layer 11. The second terminal ACn is electrically connected to the second lead-out electrode layer 12. The third terminal DCp is electrically connected to the first control electrode layer 21. The fourth terminal DCn is electrically connected to the second control electrode layer 22.

The second control electrode layer 22 faces the first control electrode layer 21. The second dielectric layer 32 is disposed at least between the first control electrode layer 21 and the second control electrode layer 22. The first lead-out electrode layer 11 and the second lead-out electrode layer 12 face each other via the second dielectric layer 32 therebetween. The first lead-out electrode layer 11 and the second lead-out electrode layer 12 are arranged at a portion which causes an electric field along a direction intersecting an electric field vector produced between the first control electrode layer 21 and the second control electrode layer 22 when the control voltage is applied between the first control electrode layer 21 and the second control electrode layer 22. According to the present embodiment, the first control electrode layer 21 and the second control electrode layer 22 face each other in the X direction. Also, the first lead-out electrode layer 11 and the second lead-out electrode layer 12 face each other in the Z direction.

As shown in FIG. 4, the variable capacitor C2 has a laminated structure. Specifically, the first dielectric layer 31 is disposed on the first lead-out electrode layer 11. The first control electrode layer 21, the second control electrode layer 22 and the second dielectric layer 32 are disposed on the first dielectric layer 31. The second dielectric layer 32 covers the first control electrode layer 21 and the second control electrode layer 22. The second lead-out electrode layer 12 is disposed on the second dielectric layer 32. An in-plane direction of each layer is defined as XY direction. A lamination direction where respective layers are laminated is defined as the Z direction.

As shown in FIG. 3, the first control electrode layer 21 and the second control electrode layer 22 are each configured to have a plate-like shape having a longitudinal axis in the Y direction. The first control electrode 21 and the second control electrode 22 are arranged to be alternately positioned with an interval therebetween. The end portions of respective first control electrode layers 21 in-Y direction are electrically connected to the first lead-out electrode common layer 41. The end portions of respective second control electrode layers 22 in +Y direction are electrically connected to the second lead-out electrode common layer 42.

In the X direction, a structure in which the first control electrode layer 21 and the second control electrode layer 22 are alternately arranged via the second dielectric layer 32 therebetween is referred to as a first structure ST1. Since the first control electrode layer 21 and the second control electrode layer 22 are alternately arranged, whereby the capacitor formed between the first control electrode layer 21 and the second control electrode layer 22 are mutually connected in parallel, the capacitance of the variable capacitor C1 can be larger.

As shown in FIG. 4, the second dielectric layer 32 is disposed at least between the first control electrode layer 21 and the second control electrode layer 22. Specifically, the second dielectric layer 32 is disposed in a control region RG1 positioned between the first control electrode layer 21 and the second control electrode layer 22. Thus, in the case where the control voltage as a DC voltage is applied between the first control electrode layer 21 and the second control electrode layer 22, an electric field vector substantially parallel to the X direction is produced in the control region RG1.

The first lead-out electrode layer 11 and the second lead-out electrode layer 12 face each other via the second dielectric layer 32 in the Z direction. Thus, the electric field vector produced in the control region RG1 when the AC voltage is applied between the first lead-out electrode layer 11 and the second lead-out electrode layer 12 substantially crosses the voltage vector produced in the control region RG1 when the control voltage is applied between the first control electrode layer 21 and the second control electrode layer 22. According to the present embodiment, the electric field vector produced in the control region RG1 when the AC voltage is applied between the first lead-out electrode layer 11 and the second lead-out electrode layer 12 substantially crosses the voltage vector produced in the control region RG1 when the control voltage is applied between the first control electrode layer 21 and the second control electrode layer 22.

A direction where the first lead-out electrode layer 11 and the second lead-out electrode layer 12 face each other and a direction where the first control electrode layer 21 and the second control electrode layer 22 face each other are different. Thus, a distance between the first lead-out electrode layer 11 and the second lead-out electrode layer 12 and a distance between the first control electrode layer 21 and the second control electrode layer 22 can be set independently. The distance between the first control electrode layer 21 and the second control electrode layer 22 can be set shorter without shortening the distance between the first lead-out electrode layer 11 and the second lead-out electrode layer 12. Hence, a distance between the first control electrode layer 21 and the second control electrode layer 22 is shortened while maintaining a distance between the first lead-out electrode layer 11 and the second lead-out layer 12 capable of withstanding the voltage applied therebetween, whereby an electric field applied between the first control electrode layer 21 and the second control electrode layer 22 can be larger. Accordingly, the control voltage can be set to be lowered.

According to the present embodiment, the first dielectric layer 31 and the second dielectric layer 32 contain the same ferroelectric material. In more detail, the first dielectric layer 31 and the second dielectric layer 32 contain PVDF (i.e. polyvinylidene fluoride). As other example, the first dielectric layer 31 and the second dielectric layer 32 may contain ferroelectric polymer of fluorocarbon resin such as P (VDF-TrFE) (i.e. poly (vinylidene fluoride-trifluoro ethylene)). The first dielectric layer 31 contains ferroelectrics, thereby causing the first dielectric layer 31 to serve as a variable capacitor.

As another example of the first dielectric layer 31 and the second dielectric layer 32, the first dielectric layer 31 and the second dielectric layer 32 may contain mutually different ferroelectric materials.

The PVDF molecule is made of hydrogen atoms and fluorine atoms coupled to a carbon chain. Since the hydrogen atom is positively charged and the fluorine atom is negatively charged, the PVDF molecule has a dipole moment. In the case where the PVDF molecules are aggregated due to intermolecular forces, directions where carbon chains of respective PVDF molecules extend are aligned. The hydrogen atoms and the fluorine atoms are positioned along a direction perpendicular to a direction where the carbon chains extend. Hence, according to PVDF crystal, spontaneous polarization occurs. In the case where electric field is applied to the PVDF crystal, orientation of the polarization changes so as to rotate around the X axis as the center axis which is a direction where the carbon chain extends. Therefore, even in a case where the control voltage is applied, by applying the AC voltage between the first lead-out electrode layer 11 and the second lead-out electrode layer 12, thereby changing the orientation of the polarization. Accordingly, the PVDF material is utilized for the second dielectric layer 32, thereby providing the variable capacitor C1 of which the relative dielectric constant change when the voltage value of the control voltage is changed.

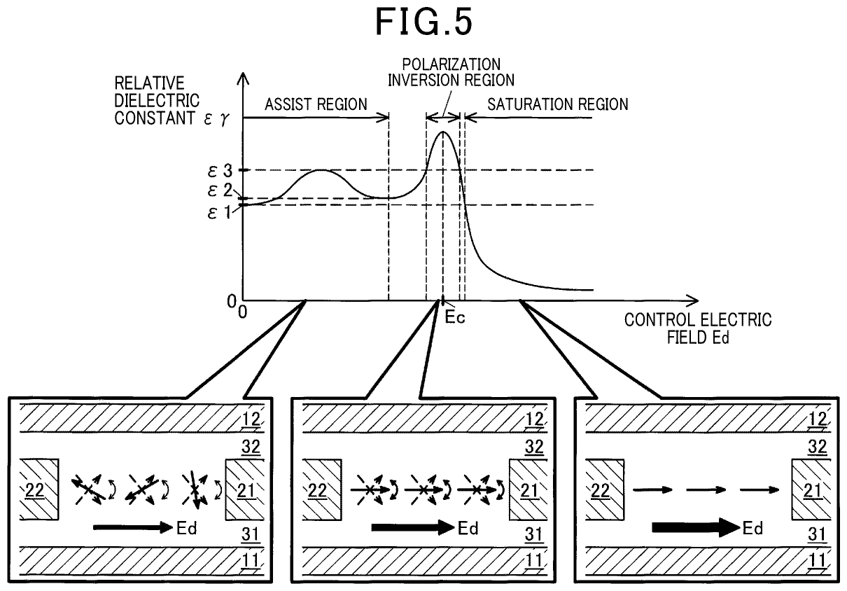

FIG. 5 illustrates a relationship between a magnitude of the control electric field Ed produced in response to the control voltage applied between the first control electrode layer 21 and the second control electrode layer 22, and the relative dielectric constant εr when the AC voltage is applied between the first lead-out electrode layer 11 and the second lead-out electrode layer 12. The variable capacitor C1 has dielectric characteristics having two peaks of the relative dielectric constant εr.

The ferroelectric material is spontaneously polarized at the control electric field of 0 V/m. When setting the control electric field to reach a coercive electric field Ec, the spontaneous polarization becomes 0 and the relative dielectric constant εr becomes maximum value. Since the dipole moment is likely to move, around the coercive electric field Ec, in a direction depending on the AC voltage applied between the first lead-out electrode layer 11 and the second lead-out electrode layer 12, the relative dielectric constant εr may become larger.

When the control electric field Ed becomes larger than the coercive electric field Ec, the relative dielectric constant εr becomes smaller. This is because electric dipole is restricted by the control electric field Ed and difficult to move depending on the AC voltage.

According to the present embodiment, the direction of the control electric field Ed crosses the direction of the electric field produced by an application of the AC voltage. Further, for the PVDF contained in the second dielectric layer 32, the direction of the polarization rotates around the carbon chain as the rotational axis. Hence, a peak of the relative dielectric constant εr appears even in a region of the control electric field Ed which is smaller than the coercive electric field Ec. This is because, when the control electric field Ed is applied, the electric dipole is likely to move when the AC voltage is applied compared to a case where the control electric field Ed is not applied.

The dielectric characteristics of the variable capacitor C1 has an assist region, a polarization inversion region and a saturation region. When applying the control voltage of the assist region, movement of the polarization in the second dielectric layer 32 is assisted. Specifically, the assist region is formed in which the control electric field Ed is smaller than the coercive electric field Ec and the relative dielectric constant εr is larger than the relative dielectric constant ε1 and smaller than the relative dielectric constant ε2. Here, the relative dielectric constant ε1 is defined as a relative dielectric constant εr when the control electric field Ed is 0. The relative dielectric constant ε2 is the minimum point between two peaks of the relative dielectric constant εr.

In the case where the control voltage in the polarization inversion region including the voltage of the coercive electric field Ec is applied, the polarization of the second dielectric layer 32 is likely to be inverted depending on the AC voltage compared to that of the assist region. Specifically, the polarization inversion region is in an electric field range where the control electric field Ed includes the coercive electric field Ec, and serves as a region where the relative dielectric constant εr is higher than the peak value ε3 of the relative dielectric constant εr in the assist region.

When the control voltage in the saturation region is applied, movement of the polarization in the second dielectric layer 32 is restricted. Specifically, the saturation region is a region in which the control electric field Ed is larger than the coercive electric field Ec.

As described above, the control electric field Ed in the assist region is applied, thereby causing movement of the polarization to be easier compared to a case where the control electric field Ed is not applied. Thus, the control electric field Ed in the assist region is applied to the variable capacitor C1, whereby the capacitance of the variable capacitance C1 can be larger than the capacitance in the case where the control electric field Ed is not applied.

Also, the control electric field Ed in the polarization inversion region is applied, whereby movement of the polarization can readily be accomplished compared to a case of that in the assist region. Hence, by applying the control electric field Ed in the polarization inversion region, the capacitance of the variable capacitor C1 can be larger than that of a case where the control electric field Ed in the assist region is applied.

Further, the control electric field ED in the saturation region is applied, thereby causing the polarization not to easily move. Hence, the control electric field Ed in the assist region is applied to the variable capacitor C1, whereby the capacitance of the variable capacitor C1 can be smaller than the capacitance in the case where the control electric field Ed in the assist region is not applied. Hence, according to the variable capacitor C1, by adjusting the magnitude of the control electric field Ed, the capacitance value of the variable capacitor C1 can be set to be a desired capacitance value.

### A5. Circuit Configuration of Control Voltage Application Circuit

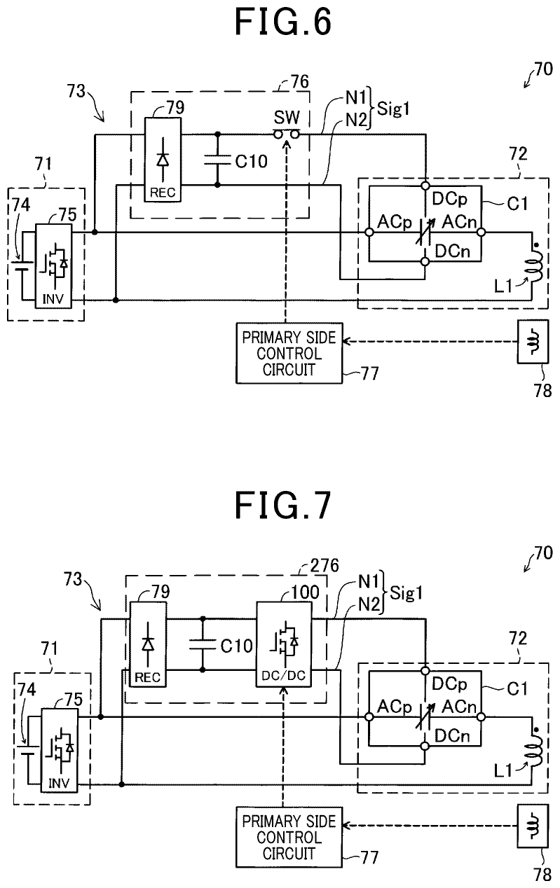

As shown in FIG. 6, a control voltage application circuit 76 includes a rectifier 79, a smoothing capacitor C10 and a switch SW. The rectifier 79 rectifies AC current outputted from the AC power source 71 and outputs a DC voltage to a wiring N1 and a wiring N2. For the rectifier 79, a diode bridge circuit can be utilized for example. The voltage applied to the wiring N1 is higher than the voltage applied to the wiring N2. A switch SW is disposed on the wiring N1. The switch N1 is configured of a transistor for example. A smoothing capacitor C10 is connected between the wiring N1 and the wiring N2. Specifically, the changing signal Sig1 is a voltage between the wiring N1 and the wiring N2.

The wiring N1 is connected to a third terminal DCp of the variable capacitor C1. The wiring N2 is connected to a fourth terminal DCn of the variable capacitor C1. A wiring connected to one output terminal of the inverter 75 is connected to the first terminal ACp of the variable capacitor C1. The wiring connected to the other output terminal of the inverter 75 is connected to the second terminal ACn of the variable capacitor C1.

The primary side control circuit 77 outputs a signal for setting the switch SW to be at an opened state or a conduction state to the control voltage application circuit 76. Specifically, the primary side control circuit 77 outputs a signal for setting the switch SW to be in the opened state in the case where the power supply apparatus 70 is set to be in the power supply state. The control voltage application circuit 76 performs a supply operation for setting the switch SW to be in the opened state when receiving a signal from the primary side control circuit 77. In the supply operation, the control voltage application circuit 76 sets the control voltage to be 0 volts as a first control voltage. Thus, the control voltage Vd applied between the first control electrode layer 21 and the second control electrode layer 22 of the variable capacitor C1 becomes 0 volts. The capacitance of the variable capacitor C1 is set to be the first capacitance in which the relative dielectric constant εr of the second dielectric layer 32 is the relative dielectric constant ε1. Thus, the primary resonant circuit 72 is in a resonant state.

In contrast, when setting the power supply apparatus 70 to be in the standby state, the primary side control circuit 77 outputs a signal for setting the switch to be in the conduction state. The control voltage application circuit 76 performs a standby operation for setting the switch SW to be in the conduction state when receiving a signal from the primary side control circuit 77. In the standby state, the control voltage application circuit 76 sets the control voltage to be a voltage value as a second control voltage corresponding to the control electric field Ed in the saturation region. Thus, the control electric field Ed applied between the first control electrode layer 21 and the second control electrode layer 22 of the variable capacitor C1 is an electric field in the saturation region. The capacitance of the variable capacitor C1 is set to be the second capacitance corresponding to the relative dielectric constant εr of the second dielectric layer 32. As described above, the second capacitance is smaller than the first capacitance. Thus, the primary resonant circuit 72 is in the non-resonant state.

According to the above-described first embodiment, the first lead-out electrode layer 11 and the second lead-out electrode layer 12 are arranged at a position where an electric field is produced along a direction crossing an electric field vector produced when the control voltage is applied. Thus, a distance between the first lead-out electrode layer 11 and the second lead-out electrode layer 12 and a distance between the first control electrode layer 21 and the second control electrode layer 22 can be set independently. Hence, the control voltage can be lowered. Further, the variable capacitor C1 is utilized for the control voltage application circuit 76 that controls an operation of the non-contact power supply system 1 by adjusting the control electric field Ed applied between the first control electrode layer 21 and the second control electrode layer 22 to adjust a capacitance stored between the first lead-out electrode layer 11 and the second control electrode layer 22 in the non-contact power supply system 1. Thus, a circuit scale can be reduced compared to a configuration in which a plurality of capacitors and switches are used in order to change the capacitance of the capacitance component of the primary resonant circuit 72. Further, compared to a case where a capacitor that mechanically changes the capacitance value is used, the circuit scale can be reduced.

Moreover, the variable capacitor C1 is used for controlling an operation of the primary resonant circuit 72 by adjusting the resonant frequency of the primary resonant circuit 72. Thus, compared to a circuit configuration using a plurality of capacitors for changing the capacitance of the capacitance component in the primary resonant circuit 72, the circuit scale can be reduced.

Also, the control voltage application circuit 76 performs a power supply operation for setting the primary resonant circuit 72 to be in the resonant state by setting the control voltage Vd to be 0 volts, and a standby operation that sets the primary resonant circuit 72 to be in the non-resonant state by setting the control voltage to be a voltage corresponding to the saturation region. The variable capacitor C1 is set to be the first capacitance by setting the control voltage Vd to be 0 volts, and is set to be the second capacitance by setting the control voltage Vd to be a voltage value corresponding to the control electric field Ed in the saturation region. According to the power supply apparatus 70 that performs a non-contact power supply operation using a magnetic resonance, the power supply apparatus can be controlled whether to perform a power supply operation depending on whether the primary resonant circuit 72 is set to be in the resonant state or the resonant state. The variable capacitor C1 according to the present embodiment may preferably be applied to such the power supply apparatus 70.

Moreover, the second capacitance is smaller than the first capacitance. Thus, in the standby state of the non-contact power supply system 1, the impedance of the primary resonant circuit 72 can be set to be smaller, the current flowing through the primary coil L1 can be smaller.

### B. Second Embodiment

A power supply apparatus 70 according to the second embodiment shown in FIG. 7 differs from that of the first embodiment in that the control voltage application circuit 276 is different. For the configurations same as those in the above-described embodiment, the same reference symbols are applied and a detailed description thereof will be omitted.

The control voltage application circuit 276 according to the present embodiment includes a rectifier 79, a smoothing capacitor C10 and a DC-DC converter 100. The DC-DC converter 100 steps-down or boosts DC voltage outputted from the rectifier 79 and outputs the stepped-down voltage or boosted voltage to the wiring N1 and the wiring N2. The control voltage outputted by the control voltage application circuit 276 is the same as that in the first embodiment. The control voltage application circuit 276 outputs voltage which changes linearly with respect to time when stepping-down or boosting the voltage. Thus, since a rapid change in the current is suppressed, a surge voltage can be prevented from occurring.

### C. Third Embodiment

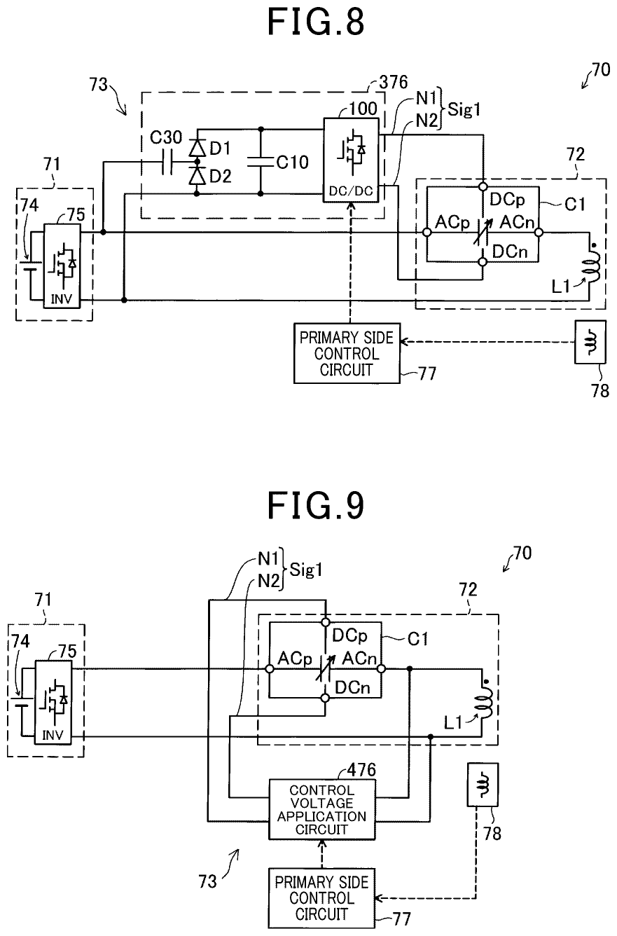

A power supply apparatus 70 according to the third embodiment shown in FIG. 8 differs from the above-described embodiments in that the control voltage application circuit 376 is different. For the configurations same as those in the above-described embodiment, the same reference symbols are applied and a detailed description thereof will be omitted.

The control voltage application circuit 376 according to the present embodiment includes a capacitor C30, a first diode D1, a second diode D2, a smoothing capacitor C10 and a DC-DC converter 100. The capacitor C30, the first diode D1, the second diode D2 and the smoothing capacitor C10 constitute a half-wave voltage doubling rectifier circuit. Thus, higher control voltage Vd can be outputted. The control voltage outputted by the control voltage application circuit 376 is similar to that in the first embodiment.

### D. Fourth Embodiment

A power supply apparatus 70 according to the fourth embodiment shown in FIG. 9 differs from the above-described embodiments in that the control voltage application circuit 476 is different. For the configurations same as those in the above-described embodiment, the same reference symbols are applied and a detailed description thereof will be omitted.

The control voltage application circuit 476 according to the present embodiment is connected to each of both terminals of the primary coil L1. The control voltage application circuit 476 convers the coil voltage as an AC voltage applied to the primary coil L1 to be a DC voltage and supplies the converted DC voltage to the wiring N1 and the wiring N2.

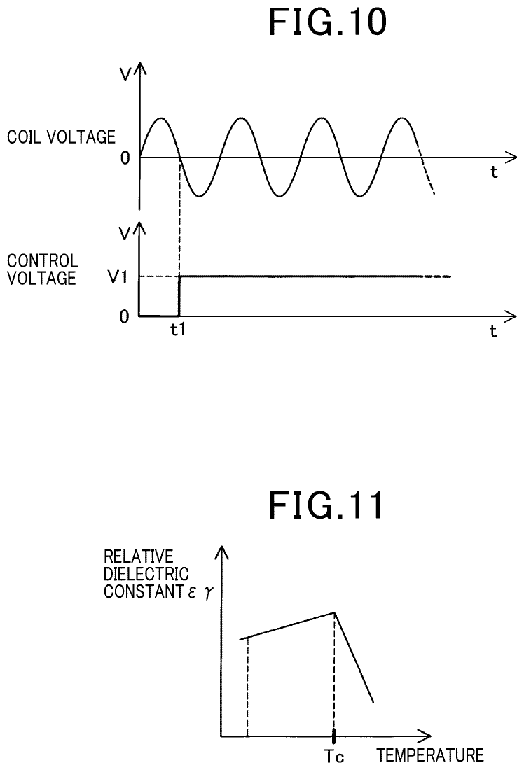

As shown in FIG. 10, the control voltage application circuit 476, when changing the operation from the power supply operation to the standby operation, starts to perform the standby operation from a time t1 where the coil voltage is substantially 0 volts. Specifically, the control voltage application circuit 476 starts to apply the control voltage Vd in the saturation region between the third terminal DCp and the fourth terminal DCn from around time t1. Here, ‘around time t’ refers to a period prior to or after the time t1 in which the voltage of the AC power is less than or equal to 10% of the maximum value of the AC power.

According to the present embodiment, the control voltage application circuit 476 performs the standby operation from the time t1. Thus, since the second dielectric layer 32 of the variable capacitor C1 is applied with the control electric field Ed in a state where it is unlikely to be influenced by an electric field due to an application of the AC power, the control electric field can be effectively applied to the second dielectric layer 32.

According to the fourth embodiment as described above, the variable capacitor C1 starts to be applied with the control voltage at a time when the voltage of the AC power applied to the primary coil L1 is around 0 volts. Thus, since the second dielectric layer 32 is applied with the control electric field Ed in a state where it is unlikely to be influenced by an electric field due to an application of the AC power, the control electric field can be effectively applied to the second dielectric layer 32.

### E. Fifth Embodiment

As shown in FIG. 11, according to the present embodiment, the second dielectric layer 32 has a dielectric characteristic in which the relative dielectric constant εr at a temperature higher than the phase transition temperature Tc as the operating temperature is lower than the relative dielectric constant εr at the phase transition temperature. Specifically, for the second dielectric layer 32, the relative dielectric constant εr decreases in the case where the temperature increases to be higher than the phase transition temperature Tc. According to the present embodiment, a dielectric used for the second dielectric layer 32 is produced such that the phase transition temperature Tc is lower than the operating temperature when the power supply apparatus 70 is in an abnormal state. Thus, in the case where the control circuit 73 is at a high temperature due to an occurrence of an abnormality, the capacitance value of the variable capacitor C1 is lowered. Hence, the current is unlikely to flow through the primary resonant circuit 72, whereby the primary resonant circuit 72 can be protected.

According to the above-described fifth embodiment, the second dielectric layer 32 has dielectric characteristics in which the relative dielectric constant εr becomes smaller at a temperature higher than the phase transition temperature Tc. In an abnormal state of the power supply apparatus 70, the capacitance value of the capacitor C1 becomes small. Hence, the current flowing through the primary coil L1 is caused to be small, thereby protecting the primary resonant circuit 72.

### F. Other Embodiment

(F1) According to the above-described first embodiment, the second dielectric layer 32 contains ferroelectric polymer. As other embodiments, the second dielectric layer 32 may contain an inorganic ferroelectric such as barium titanium (BaTiO₃). Even for the inorganic ferroelectric, the relative dielectric constant εr changes depending on the magnitude of the control voltage. Hence, the variable capacitor C1 can be used as a dielectric layer. An inorganic ferroelectric in which polarization occurs in plural directions may more preferably be used. This is because, since the relative dielectric constant changes depending on the magnitude of the control voltage even in the case where a direction where the control voltage is applied and a direction where the AC voltage is applied are different, the variable capacitance C1 having a favorable variable rate can be provided.

### (F2)

According to the above-described first embodiment, the control voltage application circuit 76 applies, in the standby state of the power supply apparatus 70, a control voltage of the saturation region and does not apply a control voltage in the transmission state of the power supply apparatus 70. As other embodiments, the control voltage application circuit 76 may apply, in the standby state of the power supply apparatus 70, a control voltage in the polarization inversion region or the assist region, and may not apply a control voltage in the transmission region of the power supply apparatus 70.

### (F3)

According to the above-described first embodiment, a so-called S-S type circuit configuration is employed in which the variable capacitor C1 is connected in series to the primary coil L1 in the primary resonant circuit 72 and the secondary capacitor C2 is connected in series to the secondary coil L2 in the secondary resonant circuit 81. However, the circuit configuration of the primary resonant circuit 72 and the circuit configuration of the secondary resonant circuit 81 are not limited to the S-S type circuit configuration. The following configurations may be utilized. (a) P—S type circuit configuration may be employed in which the variable capacitor C1 is connected in parallel to the primary coil L1 in the primary resonant circuit 72 and the secondary capacitor C2 is connected in series to the secondary coil L2 in the secondary resonant circuit 81. (b) P-SS type circuit configuration may be employed in which a capacitor connected in parallel to the primary coil L1 is provided in addition to the variable capacitor C1 connected in series to the primary coil L1, and the secondary resonant circuit 81 includes two secondary capacitor C2 are each connected in series to each of the both terminals of the secondary coil L2. (c) The primary resonant circuit 72 may be provided with a closed circuit in which the coil and the capacitor are series-connected. The coil in the closed circuit is disposed at a portion capable of being magnetically coupled to the secondary coil L2 when the primary coil L1 and the secondary coil L2 are magnetically coupled.

(d) Further, the capacitor in the closed circuit may be connected in parallel to the coil instead of being connected in series. (e) Also, the primary resonant circuit 72 may be provided with a coil connected in series to the primary coil L1 and also provided with a capacitor connected in parallel to the coil. This coil is disposed at a portion capable of being magnetically coupled to the secondary coil L2 when the primary coil L1 and the secondary coil L2 are magnetically coupled.

### (F4)

According to the above-described first embodiment, a case is exemplified in which the variable capacitor C1 is applied to the power supply apparatus 70. However, an apparatus to which the variable capacitor C1 is applied is not limited to the power supply apparatus 70. For example, the variable capacitor C1 may be applied for an apparatus integrating a circuit that converts a frequency.

The present disclosure is not limited to the above-described embodiments and modification examples and various configurations may be utilized without departing from the spirit of the present disclosure. For example, embodiments corresponding to technical features in examples described in the summary section, or technical features in the modification examples may be appropriately replaced or combined in order to solve a part or all of issues in the above-described problems to be solved, or in order to accomplish a part or all of the above-described effects and advantages. Further, unless the above-described technical features are described as necessary in the present specification, the technical features may be appropriately omitted.

### OTHER EXAMPLES

The features of the present disclosure will be described as follows.

### Example 1

A variable capacitor (C1) used for a control circuit (73) that controls an operation of an apparatus (70), the variable capacitor comprising:
a first control electrode layer (21);
a second control electrode layer that faces the first control electrode layer (22);
a dielectric layer (32) disposed at least between the first control electrode layer and the second
control electrode layer, and
a first lead-out electrode layer (11) and a second lead-out electrode layer (12) facing each other via
the dielectric layer, wherein
the first lead-out electrode layer and the second lead-out electrode layer are arranged at a portion which causes an electric field along a direction intersecting an electric field vector produced between the first control electrode layer and the second control electrode layer in the case where a voltage is applied between the first control electrode layer and the second control electrode layer, and
a voltage to be applied between the first control electrode layer and the second control electrode layer is adjusted to adjust a capacitance value of a capacitance stored between the first lead-out electrode layer and the second control electrode layer.

### Example 2

The variable capacitor according to example 1, wherein
the apparatus includes a resonant circuit (72) configured of the variable capacitor and the primary coil (L1);
the control circuit includes a control voltage application circuit (76, 276, 376, 476) that applies a control voltage between the first control electrode layer and the second control electrode layer for changing a dielectric constant of the dielectric layer, and
the variable capacitor adjusts a capacitance thereof with the use of the control voltage, thereby adjusting a resonant frequency of the resonant circuit.

### Example 3

The variable capacitor according to example 2, wherein
the apparatus serves as a power supply apparatus that supplies power to a reception apparatus in a non-contact manner,
the control voltage application circuit is capable of performing a power supply operation in which the control voltage is set to be a first control voltage to set the resonant circuit to be in a resonant state in the case where an AC power having a predetermined operating frequency is applied to the resonant circuit, and a standby operation in which the control voltage is set to be a second control voltage different from the first control voltage to set the resonant circuit to be in a non-resonant state in the case where the AC power having the predetermined operating frequency is applied to the resonant circuit; and
the variable capacitor is set to be in a first capacitance value when the first control voltage is applied and is set to be in a second capacitance different from the first capacitance when the second control voltage is applied.

### Example 4

The variable capacitor according to example 3, wherein
the resonant circuit is a series resonant circuit; and
the second capacitance is smaller than the first capacitance.

### Example 5

The variable capacitor according to example 3 or 4, wherein
an application of the second control voltage is started from a time when the voltage of the AC power applied to the primary coil is substantially 0 volts.

### Example 6

The variable capacitor according to any one of examples 1 to 5, wherein
the dielectric layer has dielectric characteristics in which a relative dielectric constant εt a temperature higher than a predetermined operating temperature is smaller than a relative dielectric constant εt the operating temperature.

### Example 7

A power supply apparatus (70) that supplies power to a reception apparatus (80) in a non-contact manner, comprising:
a resonant circuit (72) configured of a variable capacitor (C1) and a primary coil (L1); and
a control voltage application circuit (76) that applies a control voltage to the variable capacitor, wherein
   the variable capacitor comprises:
   a first control electrode layer (21);
   a second control electrode layer (22) that faces the first control electrode layer,
   a dielectric layer (32) disposed at least between the first control electrode layer and the second control electrode layer, and
   a first lead-out electrode layer (11) and a second lead-out electrode layer (12) facing each other via the dielectric layer, wherein
   the first lead-out electrode layer and the second lead-out electrode layer are arranged at a portion which causes an electric field along a direction intersecting an electric field vector produced between the first control electrode layer and the second control electrode layer in the case where a voltage is applied between the first control electrode layer and the second control electrode layer; and
the control voltage application circuit is capable of performing a power supply operation in which the control voltage is set to be a first control voltage to set the variable capacitor to be in a first capacitance, thereby setting the resonant circuit to be in a resonant state in the case where an AC power having a predetermined operating frequency is applied to the resonant circuit, and a standby operation in which the control voltage is set to be a second control voltage different from the first control voltage to set the variable capacitor to be in a second capacitance, thereby setting the resonant circuit to be in a non-resonant state in the case where the AC power having the predetermined operating frequency is applied to the resonant circuit.

The control circuit and method thereof disclosed in the present disclosure may be accomplished by a dedicated computer constituted of a processor and a memory programmed to execute one or more functions embodied by computer programs. Alternatively, the control circuit and method thereof disclosed in the present disclosure may be accomplished by a dedicated computer provided by a processor configured of one or more dedicated hardware logic circuits. Further, the control unit and method thereof disclosed in the present disclosure may be accomplished by one or more dedicated computer where a processor and a memory programmed to execute one or more functions, and a processor configured of one or more hardware logic circuits are combined. Furthermore, the computer programs may be stored, as instruction codes executed by the computer, into a computer readable non-transitory tangible recording media.

The present disclosure has been described in accordance with the embodiments. However, the present disclosure is not limited to the embodiments and structure thereof. The present disclosure includes various modification examples and modifications within the equivalent configurations. Further, various combinations and modes and other combinations and modes including one element or more or less elements of those various combinations are within the range and technical scope of the present disclosure.

### (Conclusion)

### The Present Disclosure can be Embodied as Follows.

As a first aspect of the present disclosure, a variable capacitor used for a control circuit that controls an operation of an apparatus is provided. The variable capacitor includes: a first control electrode layer, a second control electrode layer that faces the first control electrode layer; a dielectric layer disposed at least between the first control electrode layer and the second control electrode layer; and a first lead-out electrode layer and a second lead-out electrode layer facing each other via the dielectric layer. The first lead-out electrode layer and the second lead-out electrode layer are arranged at a portion which causes an electric field along a direction intersecting an electric field vector produced between the first control electrode layer and the second control electrode layer in the case where a voltage is applied between the first control electrode layer and the second control electrode layer, and a voltage to be applied between the first control electrode layer and the second control electrode layer is adjusted to adjust a capacitance value of a capacitance stored between the first lead-out electrode layer and the second control electrode layer.

According to the first aspect, the direction of an electric field applied to the dielectric layer in the case where a DC voltage is applied between the first control electrode layer and the second control electrode layer, and the direction of an electric field applied to the dielectric layer in the case where an AC voltage is applied to the first lead-out electrode and the second lead-out electrode can be differentiated. Moreover, a distance between the first control electrode layer and the second control electrode layer and a distance between the first lead-out electrode and the second lead-out electrode can be independently set. Thus, the distance between the first control electrode layer and the second control electrode layer is shortened, whereby the electric field applied to the dielectric layer can be larger even with the same DC voltage. Hence, the DC voltage can be lowered. Further, since the capacitance of the variable capacitor C1 changes depending on the magnitude of the control voltage, the circuit scale can be smaller compared to a case where a circuit configured of a plurality of capacitors and switches is utilized in order to change the capacitance of the capacitor.

According to a second aspect, a power supply apparatus that supplies power to a reception apparatus in a non-contact manner is provided. The power supply apparatus includes: a resonant circuit configured of a variable capacitor and a primary coil; and a control voltage application circuit that applies a control voltage to the variable capacitor. The variable capacitor includes: a first control electrode layer; a second control electrode layer that faces the first control electrode layer; a dielectric layer disposed at least between the first control electrode layer and the second control electrode layer; and a first lead-out electrode layer and a second lead-out electrode layer facing each other via the dielectric layer, in which the first lead-out electrode layer and the second lead-out electrode layer are arranged at a portion which causes an electric field along a direction intersecting an electric field vector produced between the first control electrode layer and the second control electrode layer in the case where a voltage is applied between the first control electrode layer and the second control electrode layer; and the control voltage application circuit is capable of performing a power supply operation in which the control voltage is set to be a first control voltage to set the variable capacitor to be in a first capacitance, thereby setting the resonant circuit to be in a resonant state in the case where an AC power having a predetermined operating frequency is applied to the resonant circuit, and a standby operation in which the control voltage is set to be a second control voltage different from the first control voltage to set the variable capacitor to be in a second capacitance, thereby setting the resonant circuit to be in a non-resonant state in the case where the AC power having the predetermined operating frequency is applied to the resonant circuit;

According to the second aspect, the direction of an electric field applied to the dielectric layer in the case where a DC voltage is applied between the first control electrode layer and the second control electrode layer, and the direction of an electric field applied to the dielectric layer in the case where an AC voltage is applied to the first lead-out electrode and the second lead-out electrode can be differentiated. Moreover, a distance between the first control electrode layer and the second control electrode layer and a distance between the first lead-out electrode and the second lead-out electrode can be independently set. Thus, the distance between the first control electrode layer and the second control electrode layer is shortened, whereby the electric field applied to the dielectric layer can be larger even with the same DC voltage. Hence, the DC voltage can be lowered. Further, since the capacitance of the variable capacitor C1 changes depending on the magnitude of the control voltage, the circuit scale of the resonant circuit and the control voltage application circuit can be smaller compared to a case where a circuit configured of a plurality of capacitors and switches is utilized in order to change the capacitance of the capacitor.

What is claimed is:

1. A variable capacitor used for a control circuit that controls an operation of an apparatus, the variable capacitor comprising:
a first control electrode layer;
a second control electrode layer that faces the first control electrode layer;
a dielectric layer disposed at least between the first control electrode layer and the second control electrode layer, and
a first lead-out electrode layer and a second lead-out electrode layer facing each other via the dielectric layer,
wherein
the first lead-out electrode layer and the second lead-out electrode layer are arranged at a portion which causes an electric field along a direction intersecting an electric field vector produced between the first control electrode layer and the second control electrode layer in the case where a voltage is applied between the first control electrode layer and the second control electrode layer, and
a voltage to be applied between the first control electrode layer and the second control electrode layer is adjusted to adjust a capacitance value of a capacitance stored between the first lead-out electrode layer and the second control electrode layer.

2. The variable capacitor according to claim 1,
wherein
the apparatus includes a resonant circuit configured of the variable capacitor and the primary coil;
the control circuit includes a control voltage application circuit that applies a control voltage between the first control electrode layer and the second control electrode layer for changing a dielectric constant of the dielectric layer; and
the variable capacitor adjusts a capacitance thereof with the use of the control voltage, thereby adjusting a resonant frequency of the resonant circuit.

3. The variable capacitor according to claim 2,
wherein
the apparatus serves as a power supply apparatus that supplies power to a reception apparatus in a non-contact manner,
the control voltage application circuit is capable of performing a power supply operation in which the control voltage is set to be a first control voltage to set the resonant circuit to be in a resonant state in the case where an AC power having a predetermined operating frequency is applied to the resonant circuit, and a standby operation in which the control voltage is set to be a second control voltage different from the first control voltage to set the resonant circuit to be in a non-resonant state in the case where the AC power having the predetermined operating frequency is applied to the resonant circuit; and
the variable capacitor is set to be in a first capacitance value when the first control voltage is applied and is set to be in a second capacitance different from the first capacitance when the second control voltage is applied.

4. The variable capacitor according to claim 3,
wherein
the resonant circuit is a series resonant circuit; and
the second capacitance is smaller than the first capacitance.

5. The variable capacitor according to claim 3,
wherein
an application of the second control voltage is started from a time when the voltage of the AC power applied to the primary coil is substantially 0 volts.

6. The variable capacitor according to claim 1,
wherein
the dielectric layer has dielectric characteristics in which a relative dielectric constant εt a temperature higher than a predetermined operating temperature is smaller than a relative dielectric constant εt the operating temperature.

7. A power supply apparatus that supplies power to a reception apparatus in a non-contact manner, comprising:
a resonant circuit configured of a variable capacitor and a primary coil; and
a control voltage application circuit that applies a control voltage to the variable capacitor,
wherein
the variable capacitor comprises:
a first control electrode layer;
a second control electrode layer that faces the first control electrode layer;
a dielectric layer disposed at least between the first control electrode layer and the second control electrode layer, and
a first lead-out electrode layer and a second lead-out electrode layer facing each other via the dielectric layer,
wherein
the first lead-out electrode layer and the second lead-out electrode layer are arranged at a portion which causes an electric field along a direction intersecting an electric field vector produced between the first control electrode layer and the second control electrode layer in the case where a voltage is applied between the first control electrode layer and the second control electrode layer; and
the control voltage application circuit is capable of performing a power supply operation in which the control voltage is set to be a first control voltage to set the variable capacitor to be in a first capacitance, thereby setting the resonant circuit to be in a resonant state in the case where an AC power having a predetermined operating frequency is applied to the resonant circuit, and a standby operation in which the control voltage is set to be a second control voltage different from the first control voltage to set the variable capacitor to be in a second capacitance, thereby setting the resonant circuit to be in a non-resonant state in the case where the AC power having the predetermined operating frequency is applied to the resonant circuit.
